(19) United States
(12) Patent Application Publication
(10) Pub. No.: US 2026/0175304 A1
(43) Pub. Date: Jun. 25, 2026

(54) SHEET CUTTING DEVICE AND SHEET CUTTING METHOD

(71) Applicant: KOMATSU NTC LTD., Toyama (JP)

(72) Inventors: Masakazu SAKAI, Toyama (JP); Takashi YOTSU, Toyama (JP); Yuji KANEHIRA, Toyama (JP)

(73) Assignee: KOMATSU NTC LTD., Toyama (JP)

(21) Appl. No.: 19/429,610

(22) Filed: Dec. 22, 2025

(30) Foreign Application Priority Data
Dec. 25, 2024 (JP) 2024228260

(51) Int. Cl. B23D 25/04; B23D 33/02

(52) U.S. Cl. CPC B23D 25/04; B23D 33/02

(57) ABSTRACT

A sheet cutting device cuts an elongated sheet material into a discrete sheet material of a predetermined length, while continuing to convey the elongated sheet material from upstream to downstream, and includes: an upstream conveying mechanism which conveys a sheet material on an upstream side of a cutting position of the sheet material; a downstream conveying mechanism which conveys the sheet material on a downstream side of the cutting position; and a cutting mechanism arranged between the upstream and downstream conveying mechanisms to cut the sheet material, wherein the cutting mechanism includes a cutter moved to follow and cut the conveyed sheet material, and a feed speed of the sheet material set in the downstream conveying mechanism is faster than that set in the upstream conveying mechanism.

### CROSS-REFERENCE TO RELATED APPLICATION

This application claims the benefit of priority under 35 U.S.C. § 119 to Japanese Patent Application No. 2024-228260 filed on Dec. 25, 2024, the entire contents of which are incorporated herein by reference.

### TECHNICAL FIELD

The present invention relates to a sheet cutting device and a sheet cutting method of a sheet material.

### BACKGROUND OF THE INVENTION

A sheet cutting device has been known that cuts a steel strip conveyed by a conveyor into a steel plate of a predetermined length by a shearing mechanism moved to follow the steel strip (see Japanese Patent No. 4369697, which is hereinbelow referred to as Patent Document 1, for example). The shearing mechanism moved to follow the steel strip holds the steel strip by a pressure pad, at a point downstream of a shearing position, when shearing the steel strip, which is conveyed from upstream to downstream, between upper and lower blades. Such a sheet cutting device allows for preventing the steel platentates obtained through shearing from being bent and/or folded midway at their edges.

### SUMMARY

### Problems to be Solved

Incidentally, a general sheet cutter to cut an elongated thin sheet into a discrete sheet of a predetermined length pauses feeding the elongated sheet every time cutting is executed. Then, if a conventional sheet cutting device (see Patent Document 1, for example) is used instead of such a sheet cutter, efficiency of cutting a sheet may be further improved. However, in the case where an object to be cut is a thin and flexible sheet, unlike a rigid steel strip, a conventional sheet cutting device (see Patent Document 1, for example) may have the elongated sheet caught between the upper and lower blades, which overlap each other during shearing. Once the elongated sheet is caught between the upper and lower blades in this way, an edge of the elongated sheet may be partially torn, to degrade quality of an obtained discrete sheet. A conventional sheet cutting device may have a risk of failing to accurately cut an elongated sheet to length, to degrade quality of the obtained discrete sheet.

The present invention is intended to provide a sheet cutting device and a sheet cutting method capable of accurately cutting an elongated sheet to length in order to efficiently obtain a high-quality discrete sheet.

### Solution to Problems

The present invention, solving the above-identified problem, provides a sheet cutting device to cut an elongated sheet material into a discrete sheet material of a predetermined length, while continuing to convey the elongated sheet material from upstream to downstream, the device including: an upstream conveying mechanism which conveys the sheet material on an upstream side of a cutting position of the sheet material; a downstream conveying mechanism which convey the sheet material on a downstream side of the cutting position; and a cutting mechanism arranged between the upstream and downstream conveying mechanisms to cut the elongated sheet material, wherein the cutting mechanism includes a cutter moved to follow and cut the conveyed sheet material, and a feed speed of the sheet material set in the downstream conveying mechanism is faster than that set in the upstream conveying mechanism.

In addition, the present invention, solving the above-identified problem, also provides a sheet cutting method to cut an elongated sheet material into a discrete sheet material of a predetermined length, while continuing to convey the elongated sheet material from upstream to downstream, the method including: applying a predetermined tension to the conveyed sheet material by setting a feed speed of the sheet material in a downstream conveying mechanism, which conveys the sheet material on a downstream side of a cutting position of the sheet material, faster than that set in an upstream conveying mechanism which conveys the sheet material on an upstream side of the cutting position; and cutting the sheet material being conveyed under a predetermined tension, while holding the sheet material on both upstream and downstream sides of the cutting position.

### Advantageous Effects of the Invention

The sheet cutting device and sheer cutting method of the present invention allow for accurately cutting an elongated sheet to length in order to efficiently obtain a high-quality discrete sheet.

### BRIEF DESCRIPTION OF DRAWINGS

FIG. 1 illustrates a configuration of a sheet cutting device according to an embodiment of the present invention;

FIG. 2 is a cross-sectional view of a sheet material to be cut by the sheet cutting device in FIG. 1;

FIG. 3 illustrates operation of the sheet cutting device to indicate coordinated action between upstream and downstream conveying mechanisms of the sheet cutting device in FIG. 1;

FIG. 4A illustrates operation of the sheet cutting device to indicate a cutter being moved to follow the conveyed sheet material;

FIG. 4B illustrates operation of the sheet cutting device to indicate a holder, which is moved to follow the conveyed sheet material, having held the sheet material between itself and a second cutting blade of the cutter;

FIG. 4C illustrates operation of the sheet cutting device to indicate a first cutting blade of the cutter abutting the sheet material held by the holder and the second cutting blade of the cutter;

FIG. 4D illustrates operation of the sheet cutting device to indicate the first cutting blade of the cutter having cut the sheet material held by the holder and the second cutting blade of the cutter; and

FIG. 5 illustrates operation of the sheet cutting device to indicate a cutting mechanism, including the cutter, returning to its initial position after cutting the conveyed sheet material.

### DETAILED DESCRIPTION

Hereinafter, a description is given in detail of an embodiment to implement a sheet cutting device and a sheet cutting method of the present invention, with reference to the drawings as appropriate. First described is the sheet cutting device of the embodiment. The sheet cutting device is a device to cut a sheet material, which is continuously conveyed from upstream to downstream by a predetermined conveying mechanism, to a predetermined length.

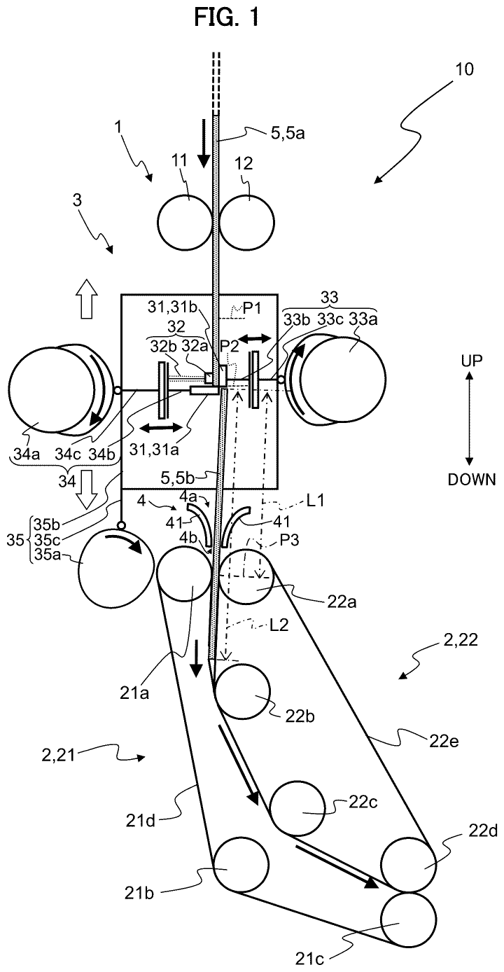

FIG. 1 illustrates a configuration of a sheet cutting device 10 according to the embodiment. Note that a vertically upper side around a cutting mechanism is defined as an upstream side and a vertically lower side as a downstream side in the case of the embodiment, but the present invention is not limited to this arrangement. As shown in FIG. 1, the sheet cutting device 10 mainly includes an upstream conveying mechanism 1, a cutting mechanism 3, a guide mechanism 4, and a downstream conveying mechanism 2, arranged from upstream to downstream in a conveying direction of a sheet material 5. In addition, although not shown, the sheet cutting device 10 includes a supply unit provided further upstream of the upstream conveying mechanism 1 to supply an elongated sheet material 5a to the upstream conveying mechanism 1.

The supply unit includes a roll section having the elongated sheet material 5a wound therearound, a rotating shaft rotatably supporting the roll section, and a servo actuator or the like applying a predetermined tension to the sheet material 5a drawn from the roll section by the upstream conveying mechanism 1. Note that the elongated sheet material 5a and a discrete sheet material 5b, cut out from the former and described below, are both referred to simply as the sheet material 5 in the following description, unless one has to be distinguished from the other.

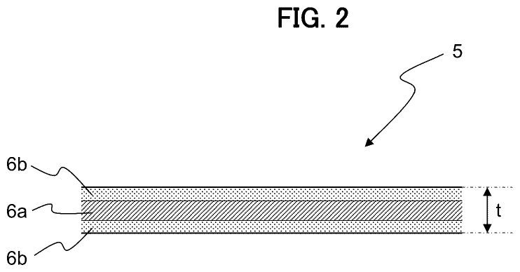

FIG. 2 is a cross-sectional view of the sheet material 5 to be cut by the sheet cutting device 10 (see FIG. 1). The sheet material 5 used with the embodiment is assumed to be a coated current collector foil used as an electrode material for secondary batteries. That is, the sheet material 5 is assumed to have a three-layer structure in which a metal foil 6a selected based on polarity, such as a copper or aluminum foil, is coated on both sides thereof with an active material layer 6b selected based on polarity and containing a predetermined active material, conductive agent, binder, and the like. A thickness “t” of the sheet material 5 is assumed to be greater than or equal to 50 μm but smaller than or equal to 200 μm, preferably around 100 μm. However, the sheet material 5 that can be cut by the sheet cutting device 10 is not limited to said material, as far as being thin and flexible, and may be other thin sheet such as a paper product, a resin film, and a metal foil.

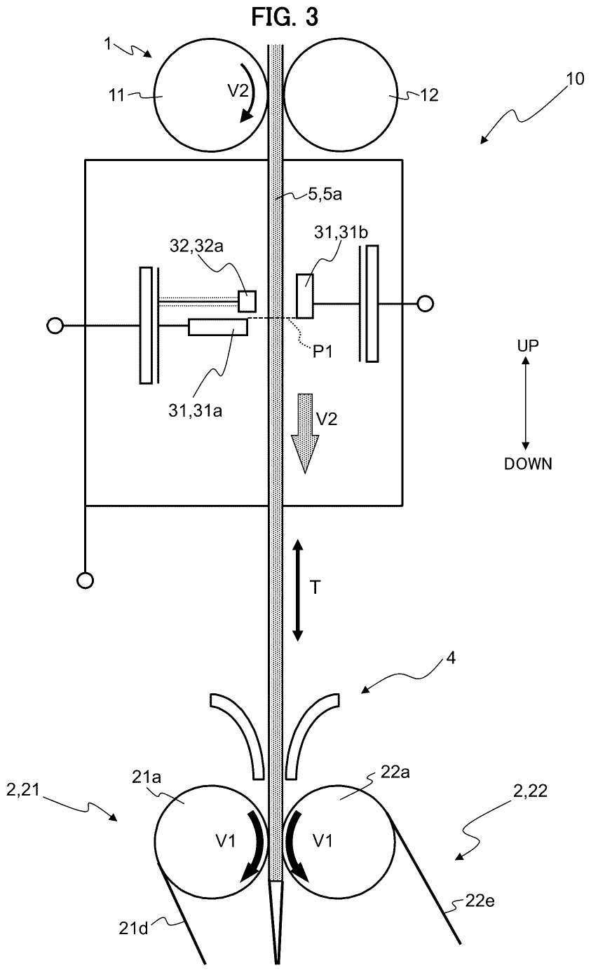

Returning to FIG. 1, the upstream conveying mechanism 1 consists of a pair of nip rollers 11 and 12. The nip roller 11 is a driving roller rotated by a motor with a reducer (not shown). The nip roller 11 of the embodiment is assumed to be made of wear-resistant hardened steel or special steel. The nip roller 12 is a driven roller pressed against, and driven by, the nip roller 11. The nip roller 12 of the embodiment is assumed to have a peripheral surface formed of an elastic material, such as rubber, with a relatively high coefficient of friction. As shown in FIG. 1, the upstream conveying mechanism 1 feeds the elongated sheet material 5a held between the nip rollers 11 and 12 to the downstream side thereof at a feed speed V2 (see FIG. 3), to be described below, which is equal to the peripheral speed of the rotating nip roller 11.

Additionally, the nip roller 11 of the upstream conveying mechanism 1 also serves as a measuring roller. That is, the nip roller 11 is equipped with a rotation detector such as an encoder, although not shown. The nip roller 11 uses this rotation detector to detect a feed length of the sheet material 5a from the upstream conveying mechanism 1 to the downstream side and outputs this detection signal. Note that the rotation detector may be provided on the nip roller 12 instead.

The cutting mechanism 3 includes a cutter 31 for cutting the sheet material 5a and a holder 32 for holding the sheet material 5a. The cutter 31 includes a first cutting blade 31a and a second cutting blade 31b for shearing the sheet material 5a. The cutter 31 is moved to follow the conveyed sheet material 5a and cuts it at a cutting position P2 preliminarily set in the sheet cutting device 10. As a result, the elongated sheet material 5a is cut into the discrete sheet material 5b of a predetermined length L2.

Additionally, the cutter 31 includes a second blade displacement mechanism 33 and a first blade displacement mechanism 34. When cutting the sheet material 5a, the second blade displacement mechanism 33 moves the second cutting blade 31b along the sheet material 5a and holds it in position. After cutting the sheet material 5a, the second blade displacement mechanism 33 retracts the second cutting blade 31b away from the sheet material 5a. In particular, the second blade displacement mechanism 33 includes a rod 33b supporting the second cutting blade 31b, a follower link 33c connected to the rod 33b, and a cam 33a linked to the follower link 33c.

The first blade displacement mechanism 34 moves the first cutting blade 31a to the second cutting blade 31b when the conveyed sheet material 5a has reached the cutting position P2, to cut the sheet material 5a at the cutting position P2. After cutting the sheet material 5a, the first blade displacement mechanism 34 retracts the first cutting blade 31a away from the sheet material 5a. In particular, the first blade displacement mechanism 34 includes a rod 34b supporting the first cutting blade 31a, a follower link 34c connected to the rod 34b, and a cam 34a linked to the follower link 34c.

In addition, the cutting mechanism 3 includes a cutter displacement mechanism 35 to vertically move the cutter 31 at a predetermined timing. The cutter displacement mechanism 35 includes a bracket 35b supporting the cutter 31, a follower link 35c connected to the bracket 35b, and a cam 35a to vertically reciprocate the bracket 35b, via the follower link 35c, within a predetermined vertical range.

In particular, the cam 35a of the cutter displacement mechanism 35 is rotated to reciprocate the cutter 31 (first and second cutting blades 31a and 31b) between an initial position P1 set downstream of the upstream conveying mechanism 1 and the cutting position P2 set downstream of the initial position P1, where the sheet material 5a is cut.

At this time, the cutter 31 (first and second cutting blades 31a and 31b) moving from the initial position P1 to the cutting position P2 follows the conveyed sheet material 5a, as described above. After cutting the sheet material 5a, the cutter 31 (first and second cutting blades 31a and 31b) returns from the cutting position P2 to the initial position P1.

Next, the holder 32 is described. As shown in FIG. 1, the holder 32 is provided upstream of the first cutting blade 31a. The holder 32 of the embodiment mainly includes a pressing member 32a and a biasing means 32b such as a resilient spring. A base end of the biasing means 32b is connected to the follower link 34c, together with a base end of the rod 34b of the first blade displacement mechanism 34. A front end of the biasing means 32b is connected to the pressing member 32a.

The pressing member 32a holds the sheet material 5a on an upstream side of the first cutting blade 31a, when the first cutting blade 31a cuts the sheet material 5a. In particular, the pressing member 32a holds the sheet material 5a between itself and the second cutting blade 31b, while the biasing means 32b presses the pressing member 32a to the sheet material 5a. Such coordinated action of the holder 32 and the cutter 31 (first and second cutting blades 31a and 31b) is described in detail below.

As shown in FIG. 1, the guide mechanism 4 is arranged downstream of the cutting mechanism 3. The guide mechanism 4 includes a pair of walls 41 arranged such that spacing between them gradually decreases from an inlet 4a to an outlet 4b for the sheet material 5. The guide mechanism 4 guides the sheet material 5, which is conveyed from the cutting mechanism 3, to the downstream conveying mechanism 2.

Next, the downstream conveying mechanism 2 (see FIG. 1) is described. As shown in FIG. 1, the downstream conveying mechanism 2 is composed of a pair of belt conveyors 21 and 22, which convey the sheet material 5 while holding it therebetween. The belt conveyor 21 includes three rollers of a driving roller 21a, a first guide roller 21b, and a second guide roller 21c, in the order from upstream to downstream, as well as a circular belt 21d stretched over these rollers.

Among the three rollers of the driving roller 21a, first guide roller 21b, and second guide roller 21c, the first guide roller 21b centrally located in the vertical direction is displaced away from the belt conveyor 22. As a result, the belt 21d is stretched over these rollers so as to form a substantially triangular shape with the driving roller 21a, first guide roller 21b, and second guide roller 21c as its vertices.

The belt conveyor 22 includes four rollers of a driving roller 22a, a first guide roller 22b, a second guide roller 22c, and a third guide roller 22d, in the order from upstream to downstream, as well as a circular belt 22e stretched over these rollers. Note that the driving roller 22a of the belt conveyor 22 is arranged at the same height in the vertical direction as the driving roller 21a of the belt conveyor 21.

As shown in FIG. 1, a position P3 of the downstream conveying mechanism 2 in the case of the embodiment is set to a vertical position of the rotational centers of the driving rollers 21a and 22a. The position P3 of the downstream conveying mechanism 2 is set to a position having a distance from the cutting position P2, where the sheet material 5a is cut by the cutting mechanism 3, shorter than that equal to the predetermined length L2 of the discrete sheet material 5b, as shown in FIG. 1. The position P3 of the downstream conveying mechanism 2 corresponds to “a position of the downstream conveying mechanism” described in a set of claims.

Among the four rollers of the driving roller 22a, first guide roller 22b, second guide roller 22c, and third guide roller 22d, the first and second guide rollers 22b and 22c located centrally in the vertical direction are arranged to line between the driving roller 21a and second guide roller 21c of the belt conveyor 21. As a result, the belt 22e is stretched over these rollers so as to form an isosceles trapezoid with the driving roller 22a, first guide roller 22b, second guide roller 22c, and third guide roller 22d as its vertices. Additionally, the first and second guide rollers 22b and 22c of the belt conveyor 22 being arranged between the driving roller 21a and second guide roller 21c of the belt conveyor 21 causes the belts 21d and 22e to contact each other between the belt conveyors 21 and 22.

The driving rollers 21a and 22a then rotate in opposite directions to each other so that the belts 21d and 22e are moved downward between the belt conveyors 21 and 22. In particular, the driving roller 21a rotates clockwise and the driving roller 22a rotates counterclockwise in an example shown in FIG. 3 which is referred to next.

FIG. 3 illustrates operation of the sheet cutting device 10 to indicate coordinated action between the upstream and downstream conveying mechanisms 1 and 2. As shown in FIG. 3, the feed speed V1 of the sheet material 5 by belts 21d and 22e set in the downstream conveying mechanism 2 is substantially equal to an outer-peripheral speed of the belts 21d and 22e wound around the driving rollers 21a and 22a, respectively.

The feed speed V1 of the sheet material 5 set in the downstream conveying mechanism 2 in the case of the embodiment is faster than the feed speed V2 set in the upstream conveying mechanism 1. The feed speed V1 of the embodiment is set to be around 1% faster than the feed speed V2, but the present invention is not limited thereto. In addition, the feed speed V1 may be adjusted by a predetermined controller (not shown) controlling the downstream conveying mechanism 2, based on a signal of detected tension of the sheet material 5, which is output from a detection roller (not shown) provided midway in a conveying path of the sheet material 5 and having a load cell.

The belts 21d and 22e of the downstream conveying mechanism 2, with the feed speed set to V1 as described above, results in applying a predetermined tension T to the sheet material 5 conveyed at the feed speed V2, while slidably contacting it, as shown in FIG. 3. In other words, the sheet material 5 conveyed at the feed speed V2 is dynamically held at two points of the upstream and downstream conveying mechanisms 1 and 2, respectively provided upstream and downstream of the cutting mechanism 3.

Note that FIG. 3 shows that the cutter 31 (first and second cutting blades 31a and 31b) of the cutting mechanism 3 is arranged at the initial position P1. That is, the first and second cutting blades 31a and 31b are positioned away from the sheet material 5. Likewise, the pressing member 32a of the holder 32 is also positioned away from the sheet material 5. Incidentally, a vertical position of the cutter 31 (first and second cutting blades 31a and 31b) in the case of the embodiment is set based on the position where a shearing portion of the first cutting blade 31a horizontally overlaps with that of the second cutting blade 31b.

Next, a description is given of coordinated action of the first cutting blade 31a (see FIG. 1), second cutting blade 31b (see FIG. 1), and pressing member 32a (see FIG. 1). As described above, the first and second cutting blades 31a and 31b (see FIG. 1) are moved to follow the conveyed sheet material 5a (see FIG. 1) from the initial position P1 (see FIG. 1) to the cutting position P2 (see FIG. 1). The pressing member 32a (see FIG. 1) is also moved to follow the conveyed sheet material 5a (see FIG. 1).

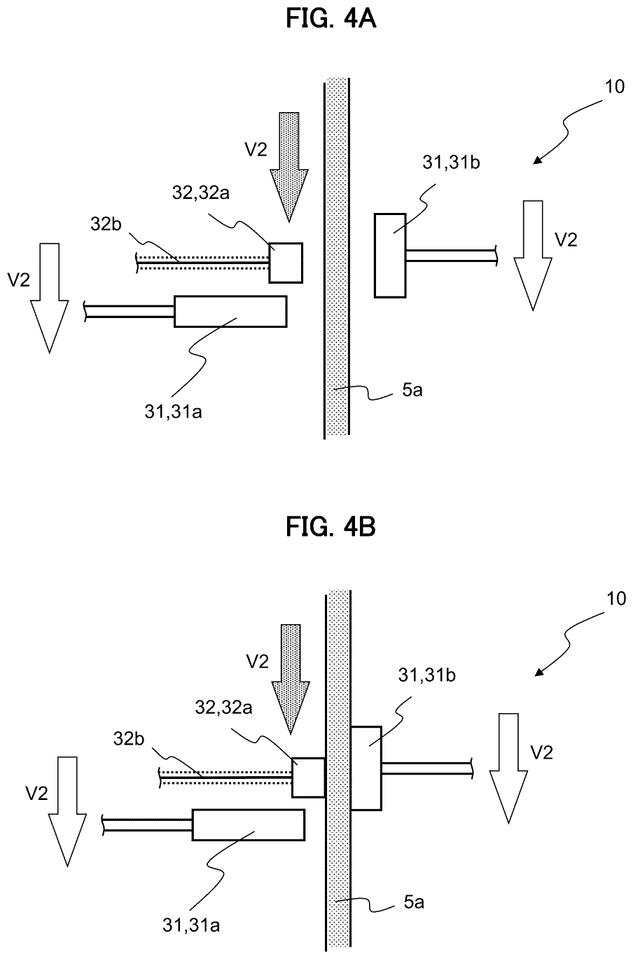

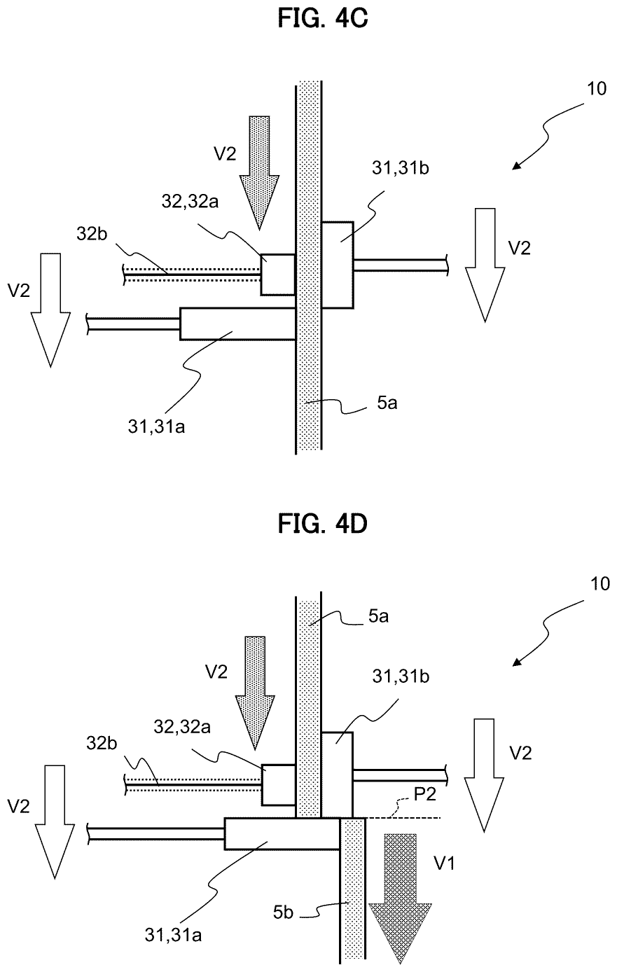

FIG. 4A illustrates operation of the sheet cutting device 10 to indicate the cutter 31 being moved to follow the conveyed sheet material 5a. FIG. 4B illustrates operation of the sheet cutting device 10 to indicate the holder 32, which is moved to follow the conveyed sheet material 5a, having held the sheet material 5a between itself and the second cutting blade 31b of the cutter 31. FIG. 4C illustrates operation of the sheet cutting device 10 to indicate the first cutting blade 31a of the cutter 31 abutting the sheet material 5a held by the holder 32 and second cutting blade 31b of the cutter 31. FIG. 4D illustrates operation of the sheet cutting device 10 to indicate the first cutting blade 31a of the cutter 31 having cut the sheet material 5a held by the holder 32 and second cutting blade 31b of the cutter 31.

As shown in FIG. 4A, the first cutting blade 31a, second cutting blade 31b, and pressing member 32a are moved at the speed V2 to follow the sheet material 5a conveyed at the feed speed V2, maintaining separation from the sheet material 5a.

Next, the pressing member 32a and second cutting blade 31b contact the sheet material 5a, while being moved at the speed V2 to follow it, as shown in FIG. 4B. Then, the pressing member 32a holds the sheet material 5a between itself and the second cutting blade 31b by way of a resilient force of the biasing means 32b. As a result, the sheet material 5a is held on the upstream side of the first cutting blade 31a, between the pressing member 32a and second cutting blade 31b, and also on the downstream side of the first cutting blade 31a, between the belt conveyors 21 and 22 of the downstream conveying mechanism 2 (see FIG. 3).

Next, when the first and second cutting blades 31a and 31b have reached the cutting position P2 preliminarily set in the sheet cutting device 10, the first cutting blade 31a is advanced to the second cutting blade 31b, as shown in FIG. 4C. As a result, the first cutting blade 31a contacts the sheet material 5a. At this time, the sheet material 5a under the predetermined tension T (see FIG. 3) is dynamically held at two points of the upstream and downstream conveying mechanisms 1 and 2 (see FIG. 3) and statically held between the pressing member 32a and second cutting blade 31b.

Then, the first cutting blade 31a is further advanced to the second cutting blade 31b, to shear the sheet material 5a into the discrete sheet material 5b (see FIG. 1) of the predetermined length L2 (see FIG. 1), as shown in FIG. 4D.

The discrete sheet material 5b after having been cut out through shearing is conveyed downstream at the feed speed V1 of the downstream conveying mechanism 2 (see FIG. 3). At this time, the position P3 (see FIG. 1) of the downstream conveying mechanism 2 (see FIG. 1) is set to a position having a distance from the cutting position P2 shorter than that equal to the predetermined length L2 (see FIG. 1) of the discrete sheet material 5b (see FIG. 1). This ensures that the discrete sheet material 5b is reliably conveyed downstream without being derailed from the conveying path. Meanwhile, the elongated sheet material 5a continues to be conveyed downstream at the feed speed V2 of the upstream conveying mechanism 1 (see FIG. 3).

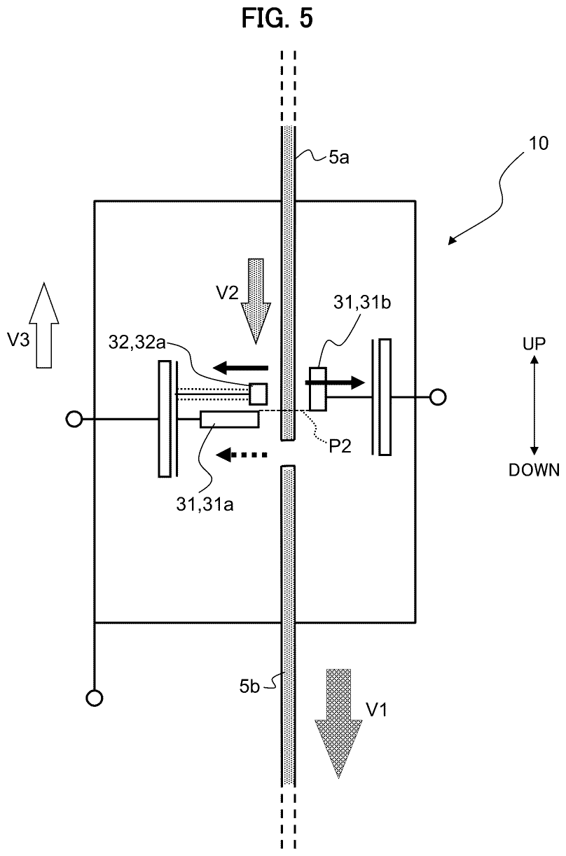

FIG. 5 illustrates operation of the sheet cutting device 10 to indicate the cutter 31 returning to the initial position P1 after cutting the sheet material 5a. As shown in FIG. 5, the first and second cutting blades 31a and 31b after cutting the sheet material 5a is moved upstream or to the initial upper position P1 (see FIG. 3) at the speed V3, while being moved away from the sheet material 5a. The holder 32 having the pressing member 32a is also moved at the speed V3, along with the first and second cutting blades 31a and 31b. Incidentally, the speed V3 is preferably set equal to or greater than the speed V2.

The timing of moving the cutter 31 and holder 32 by the second blade displacement mechanism 33 (see FIG. 1), first blade displacement mechanism 34 (see FIG. 1), and cutter displacement mechanism 35 (see FIG. 1), as described above, is set every time the discrete sheet material 5b (see FIG. 1) is cut out from the elongated sheet material 5a (see FIG. 1). That is, the timing of moving the cutter 31 and holder 32 is set every time the length of the sheet material 5a conveyed by the upstream conveying mechanism 1 (see FIG. 1) reaches the predetermined length L2 (see FIG. 1) of the discrete sheet material 5b, which has been preliminarily set. In particular, the sheet cutting device 10 of the embodiment uses a predetermined controller (not shown) to control the timing of moving the cutter 31 and holder 32, based on a detection signal output from the rotation detector of the upstream conveying mechanism 1, which also serves as a measuring roller.

The sheet cutting device 10 (see FIG. 1) having such a controller executes a sheet cutting method to cut the elongated sheet material 5 (see FIG. 1) into the discrete sheet material 5 of the predetermined length L2 (see FIG. 1), while continuing to convey the elongated sheet material 5 from upstream to downstream, the method including: applying the predetermined tension T (see FIG. 3) to the conveyed sheet material 5 (see FIG. 1) by setting the feed speed V1 (see FIG. 3) of the sheet material 5 (see FIG. 1) in the downstream conveying mechanism 2 (see FIG. 1), which conveys the sheet material 5 (see FIG. 1) on a downstream side of the cutting position P2, set faster than the feed speed V2 (see FIG. 3) of the sheet material 5 (see FIG. 1) set in the upstream conveying mechanism 1 (see FIG. 1) which conveys the sheet material 5 (see FIG. 1) on an upstream side of the cutting position P2; and cutting the sheet material 5 (see FIG. 1) being conveyed under the predetermined tension T (see FIG. 3), while holding the sheet material 5 (see FIG. 1) on both upstream and downstream sides of the cutting position P2 (see FIG. 1).

### Advantageous Effects

Next, advantageous effects achieved by the embodiment are described. The sheet cutting device 10 of the embodiment is a device to cut the elongated sheet material 5a into the discrete sheet material 5b of the predetermined length L2, while continuing to convey the elongated sheet material 5a from upstream to downstream, the device including: the upstream conveying mechanism 1 which conveys the sheet material 5a on an upstream side of the cutting position P2; the downstream conveying mechanism 2 which conveys the sheet material 5a on a downstream side of the cutting position P2; and the cutting mechanism 3 arranged between the upstream and downstream conveying mechanisms 1 and 2, to cut the sheet material 5a, wherein the cutting mechanism 3 includes the cutter 31 moved to follow and cut the conveyed sheet material 5a, and the feed speed V1 of the sheet material 5a set in the downstream conveying mechanism 2 is faster than the feed speed V2 of the sheet material 5a set in the upstream conveying mechanism 1.

According to the sheet cutting device 10, the sheet material 5b is cut by the cutting mechanism 3, while being dynamically held by the upstream and downstream conveying mechanisms 1 and 2 so that it is under the tension T, to prevent the sheet material 5b from being caught between the upper and lower blades. As a result, the sheet cutting device 10 can accurately cut the elongated sheet material 5a to length in order to efficiently obtain the high-quality discrete sheet material 5b.

In addition, according to the sheet cutting device 10, a difference in the feed speeds (V1−V2) between the upstream and downstream conveying mechanisms causes the sheet material 5a to be under the tension T. This allows for reducing the sheet cutting device 10 in size and prevents the sheet material 5a from being sagged.

Further, the above-described sheet cutting device 10 has the position P3 of the downstream conveying mechanism 2 set to a position having a distance from the cutting position P2, where the sheet material 5a is cut by the cutting mechanism 3, shorter than that equal to the predetermined length L2 of the discrete sheet material 5b.

According to the sheet cutting device 10, the lower end of the discrete sheet material 5b is always held by the downstream conveying mechanism 2, to ensure that the discrete sheet material 5b is reliably conveyed downstream without being derailed from the conveying path.

Still further, in the case of the above-described sheet cutting device 10, the cutter 31 has the first and second cutting blades 31a and 31b for shearing the sheet material 5a, and the cutting mechanism 3 further includes the holder 32 for holding the sheet material 5a at a point upstream of the first cutting blade 31a when cutting the sheet material 5a.

According to the sheet cutting device 10, the sheet material 5a is held not only by the upstream and downstream conveying mechanisms 1 and 2, but also by the holder 32, as described above. This allows the sheet cutting device 10 to cut the elongated sheet material 5a to length more accurately.

Still further, in the case of the above-described sheet cutting device 10, the holder 32 includes the pressing member 32a having the biasing means 32b for pressing the sheet material 5a to the second cutting blade 31b, wherein the first cutting blade 31a shears the sheet material 5a held between the second cutting blade 31b and pressing member 32a.

According to the sheet cutting device 10, the first cutting blade 31a cuts the sheet material 5a pressed by the pressing member 32a using the biasing means 32b, to allow for cutting the elongated sheet material 5a to length even more accurately.

Still further, in the case of the above-described sheet cutting device 10, the downstream conveying mechanism 2 comprises a pair of the belt conveyors 21 and 22 which convey the sheet material 5a, while holding it therebetween.

According to the sheet cutting device 10, the sheet material 5a is conveyed while being held by the pair of the belt conveyors 21 and 22, to allow the sheet material 5a under the predetermined tension T to be stably conveyed downstream.

Still further, in the case of the above-described sheet cutting device 10, the direction of the sheet material 5a being conveyed is set vertically downward.

According to the sheet cutting device 10, the sheet material 5a can be stably conveyed downstream without resisting gravity, even if it is thin and flexible.

Still further, the above-described sheet cutting device 10 comprises the guide mechanism 4 arranged downstream of the cutting mechanism 3 to guide the sheet material 5a from the cutting mechanism 3 to the downstream conveying mechanism 2, wherein the guide mechanism 4 includes a pair of the walls 41 arranged such that spacing between them gradually decreases from the inlet 4a to the outlet 4b for the sheet material 5a.

According to the sheet cutting device 10, the sheet material 5a can be conveyed more reliably from the cutting mechanism 3 to the downstream conveying mechanism 2.

Still further, in the case of the above-described sheet cutting device 10, the sheet material 5a is an electrode material for secondary batteries, in which the metal foil 6a is coated on both sides thereof with the active material layer 6b.

According to the sheet cutting device 10, the conveyed sheet material 5a can be prevented from being sagged, to reduce the likelihood of the electrode material for secondary batteries, as the sheet material 5a, suffering delamination.

Still further, the sheet cutting method of the embodiment is a method to cut the elongated sheet material 5 into the discrete sheet material 5b of the predetermined length L2, while continuing to convey the elongated sheet material 5a from upstream to downstream, the method including: applying the predetermined tension T to the conveyed sheet material 5a by setting the feed speed V1 of the sheet material 5 in the downstream conveying mechanism 2, which conveys the sheet material 5 on a downstream side of the cutting position P2, faster than the feed speed V2 of the sheet material 5 set in the upstream conveying mechanism 1 which conveys the sheet material 5 on an upstream side of the cutting position P2; and cutting the sheet material 5a being conveyed under the tension T, while holding the sheet material 5a on both upstream and downstream sides of the cutting position P2.

According to this sheet cutting method, the sheet material 5b is cut by the cutting mechanism 3, while being dynamically held by the upstream and downstream conveying mechanisms 1 and 2 so that it is under the tension T, to prevent the sheet material 5b from being caught between the upper and lower blades, unlike any sheet cutting methods implemented by conventional sheet cutting devices (see Patent Document 1, for example). This sheet cutting method allows for accurately cutting the elongated sheet material 5a to length in order to efficiently obtain the high-quality discrete sheet material 5b.

Hereinabove, the embodiment of the present invention has been described, but the present invention is not limited to the above-described embodiment and can be implemented in various forms. A shearing blade comprising the first and second cutting blades 31a and 31b is shown in the embodiment as an example of the cutter 31, but the cutter 31 is not limited to this and may have other cutter, such as a laser cutter, applied thereto.

### LIST OF REFERENCE SIGNS

1: upstream conveying mechanism, 2: downstream conveying mechanism, 3: cutting mechanism, 4: guide mechanism, 4a: inlet for sheet material, 4b: outlet for sheet material, 5: sheet material, 5a: elongated sheet material, 5b: discrete sheet material, 6a: metal foil, 6b: active material layer, 10: sheet cutting device, 21: belt conveyor, 22: belt conveyor, 31: cutter, 31a: first cutting blade, 31b: second cutting blade, 32: holder, 32a: pressing member, 32b: biasing means, 41: wall, L2: predetermined length of discrete sheet material, P2: cutting position for sheet material, P3: position of downstream conveying mechanism, V1: feed speed of sheet material set in downstream conveying mechanism, and V2: feed speed of sheet material set in upstream conveying mechanism.

What is claimed is:

1. A sheet cutting device to cut an elongated sheet material into a discrete sheet material of a predetermined length, while continuing to convey the elongated sheet material from upstream to downstream, the device comprising:
an upstream conveying mechanism which conveys the sheet material on an upstream side of a cutting position of the sheet material;
a downstream conveying mechanism which conveys the sheet material on a downstream side of the cutting position; and
a cutting mechanism arranged between the upstream and downstream conveying mechanisms to cut the sheet material,
wherein the cutting mechanism includes a cutter moved to follow and cut the conveyed sheet material, and
a feed speed of the sheet material set in the downstream conveying mechanism is faster than that set in the upstream conveying mechanism.

2. The sheet cutting device according to claim 1, wherein
the position of the downstream conveying mechanism is set to a position having a distance from a cutting position, where the sheet material is cut by the cutting mechanism, shorter than that equal to a predetermined length of the discrete sheet material.

3. The sheet cutting device according to claim 1, wherein
the cutter has a first cutting blade and a second cutting blade for shearing the sheet material, and the cutting mechanism further includes a holder for holding the sheet material at a point upstream of the first cutting blade when cutting the sheet material.

4. The sheet cutting device according to claim 3, wherein
the holder includes a pressing member having a biasing means for pressing the sheet material to the second cutting blade,
wherein the first cutting blade shears the sheet material held between the second cutting blade and the pressing member.

5. The sheet cutting device according to claim 1, wherein
the downstream conveying mechanism comprises a pair of belt conveyors which convey the sheet material, while holding it therebetween.

6. The sheet cutting device according to claim 1, wherein a direction of the sheet material being conveyed is set vertically downward.

7. The sheet cutting device according to claim 6, the device further comprising:
a guide mechanism arranged downstream of the cutting mechanism to guide the sheet material from the cutting mechanism to the downstream conveying mechanism,
wherein the guide mechanism include a pair of walls arranged such that spacing between them gradually decreases from an inlet to an outlet for the sheet material.

8. The sheet cutting device according to claim 1, wherein
the sheet material is an electrode material for secondary batteries, in which a metal foil is coated on both sides thereof with an active material layer.

9. A method to cut an elongated sheet material into a discrete sheet material of a predetermined length, while continuing to convey the elongated sheet material from upstream to downstream, the method comprising:
applying a predetermined tension to a conveyed sheet material by setting a feed speed of the sheet material in a downstream conveying mechanism, which conveys the sheet material on a downstream side of a cutting position of the sheet material, faster than that set in an upstream conveying mechanism which conveys the sheet material on an upstream side of the cutting position; and
cutting the sheet material being conveyed under the predetermined tension, while holding the sheet material on both upstream and downstream sides of the cutting position.
